(19) United States
(12) Patent Application Publication
(10) Pub. No.: US 2025/0167269 A1
(43) Pub. Date: May 22, 2025

(54) SYSTEMS AND METHODS OF ACCELERATING FUEL CELL START-UP AND WARM-UP TIMES

(71) Applicant: Caterpillar Inc., Peoria, IL (US)

(72) Inventor: David Andrew Pierpont, Dunlap, IL (US)

(73) Assignee: Caterpillar Inc., Peoria, IL (US)

(21) Appl. No.: 18/512,821

(22) Filed: Nov. 17, 2023

(51) Int. Cl. H01M 8/04223; H01M 8/04701; H01M 8/04746

(52) U.S. Cl. CPC H01M 8/04268; H01M 8/04723; H01M 8/04738; H01M 8/04776; H01M 2250/20

(57) ABSTRACT

Provided herein are systems and methods for accelerating fuel cell start-up and warm-up times. A control system may detect a warm-up condition of the fuel cell; and activate a compressor to supply compressed heated air to a coolant circuit of the fuel cell during the warm-up condition.

### BACKGROUND

The present invention relates generally to the field of fuel cells, including but not limited to systems and methods of accelerating fuel cell start-up and warm-up times.

### SUMMARY

A first aspect provided herein relates to a vehicle including a fuel cell, a compressor, and a processing circuit. The compressor is arranged to supply compressed heated air to a coolant circuit of the fuel cell. The processing circuit includes one or more processors and memory, the memory storing instructions that, when executed, cause the processing circuit to: detect a warm-up condition of the fuel cell; and activate the compressor to supply compressed heated air to the coolant circuit during the warm-up condition.

In some embodiments, the fuel cell is a high-temperature proton-exchange membrane (HT-PEM) fuel cell. In some embodiments, the compressor is an eTurbo compressor. In some embodiments, the compressor is arranged to supply the compressed heated air to the coolant circuit and a stack of the fuel cell. In some embodiments, the compressor supplies the compressed air to the coolant circuit through an air side of the stack of the fuel cell.

In some embodiments, the vehicle also includes a recirculation line arranged to direct warm air of the compressed heated air back to an inlet of the compressor. In some embodiments, the instructions further cause the processing circuit to: detect, via a sensor arranged to measure a temperature of coolant of the coolant circuit, the temperature satisfies a threshold temperature; and activate the fuel cell to supply power to the vehicle. In some embodiments, the vehicle also includes a battery electrically coupled to the compressor, to supply power to the compressor during the warm-up condition.

A second aspect provided herein relates to an energy system for a vehicle including a fuel cell, a compressor arranged to supply compressed heated air to a coolant circuit of the fuel cell, and a processing circuit comprising one or more processors and memory, the memory storing instructions that, when executed, cause the processing circuit to: detect a warm-up condition of the fuel cell; and activate the compressor to supply compressed heated air to the coolant circuit during the warm-up condition.

In some embodiments of the system, the fuel cell is a high-temperature proton-exchange membrane (HT-PEM) fuel cell. In some embodiments of the system, the compressor is an eTurbo compressor. In some embodiments of the system, the compressor is arranged to supply the compressed heated air to the coolant circuit and a stack of the fuel cell. In some embodiments of the system, the compressor supplies the compressed air to the coolant circuit through an air side of the stack of the fuel cell.

In some embodiments, the system also includes a recirculation line arranged to direct warm air of the compressed heated air back to an inlet of the compressor. In some embodiments of the system, the instructions further cause the processing circuit to: detect, via a sensor arranged to measure a temperature of coolant of the coolant circuit, the temperature satisfies a threshold temperature; and activate the fuel cell to supply power to the vehicle. In some embodiments, the system also includes a battery electrically coupled to the compressor, to supply power to the compressor during the warm-up condition.

A third aspect provided herein relates to a method of heating an energy system during a start-up condition, the method including detecting, by a control system, a warm-up condition of a fuel cell for an energy system of a vehicle; and activating, by the control system, a compressor to supply compressed heated air to a coolant circuit of the fuel cell during the warm-up condition.

In some embodiments, the compressor is arranged to supply the compressed heated air to the coolant circuit and a stack of the fuel cell. In some of these embodiments, the compressor supplies the compressed air to the coolant circuit through an air side of the stack of the fuel cell.

In some embodiments, the method also includes detecting, by the control system via a sensor arranged to measure a temperature of coolant of the coolant circuit, the temperature satisfies a threshold temperature; and activating, by the control system, the fuel cell to supply power to the vehicle.

### BRIEF DESCRIPTION OF THE DRAWINGS

FIG. 1 is a block diagram of a system for accelerating fuel cell start-up and warm-up times, according to an embodiment of the present disclosure;

FIG. 2 is a schematic diagram of anode and cathode loops of a fuel cell system, according to an embodiment of the present disclosure;

FIG. 3 is a schematic diagram of coolant and high voltage loops of a fuel cell system, according to an embodiment of the present disclosure;

FIG. 4 is a flowchart showing a method of accelerating fuel cell start-up and warm-up times, according to an embodiment of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, the systems and methods described herein may be configured, designed, or otherwise arranged to accelerate fuel cell start-up and warm-up times. Fuel cells typically should reach a minimum temperature to produce power and to reach full power capability. The minimum temperature may be dependent on the fuel cell technology used in the fuel cell system. Start-up and warm-up time can be anywhere from a couple minutes to a couple hours depending on the fuel cell technology being used. For example, a proton exchange membrane (PEM) fuel cells typically operate at 70° C. (low temperature-PEM fuel cells) and 160° C. (high temperature-PEM fuel cells) coolant temperatures at fully warm conditions. Each technology may have a minimum temperature to produce any power and minimum temperature to produce maximum power and may have a battery to support the startup and warmup process until the fuel cell can produce sufficient power to sustain itself. According to the systems and methods described herein, a compressor may be provided (e.g., an eTurbo, or an electrically driven turbo compressor, a turbo compressor and expander machine) to reduce start-up and warm-up times.

According to the systems and methods described herein, a fuel cell system which includes the described solution may have reduced start-up and warm-up times. The amount of such a reduction in start-up and warm-up times may be dependent on the level of active heating using the eTurbo machine and also the thermal mass of the fuel cell system being heating. One example estimates that 10% of the rated fuel cell power being transferred as heat to the coolant can reduce warmup times by half. A typical eTurbo machine used in a fuel cell system may have an electric motor sized for about 10% of rated fuel cell power. In various embodiments of the present solution, the eTurbo machine may be driven by a battery to heat the coolant and accelerate fuel cell startup and warmup times. Additional aspects of the present disclosure, as well as additional benefits of the present solution, are described in greater detail below.

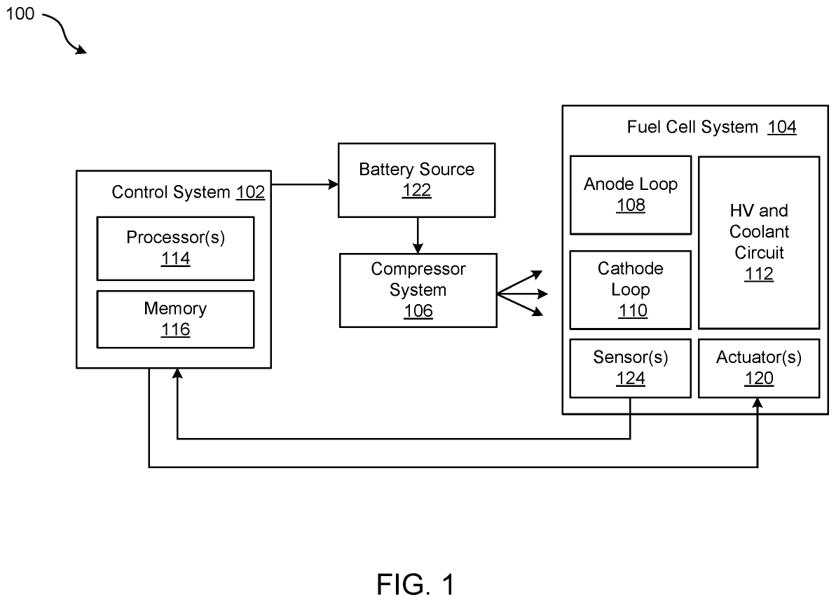

Referring now to FIG. 1, depicted is a block diagram of a system 100 for accelerating fuel cell start-up and warm-up times, according to an example implementation of the present disclosure. The system 100 may include a control system 102 communicably coupled to a fuel cell system 104 and a compressor system 106. The system 102 may be implemented in various environments or systems. For example, the system 102 may be implemented in various vehicles for supplying power to the vehicle, as a power generation system for homes or businesses (e.g., primary or back-up power), etc. In some embodiments, the system 102 may be implemented in various heavy machinery components or vehicles to supply power thereto. As described in greater detail below, the control system 102 may be configured to detect, determine, or otherwise identify a warm-up condition of the fuel cell system 104, and activate the compressor system 106 to supply compressed heated air to the fuel cell system 104 during the warm-up condition.

The fuel cell system 104 may include various types or forms of fuel cells. In some embodiments, the fuel cell system 104 may be or include a proton exchange membrane (PEM) fuel cell. For example, the fuel cell system 104 may be or include a high temperature PEM (HT-PEM) fuel cell (e.g., a fuel cell which operates at high temperatures at fully warm conditions, such as 160° C.) or a low temperature PEM (LT-PEM) fuel cell (e.g., a fuel cell which operates at low temperatures [relative to HT-PEM fuel cells] at fully warm conditions, such as 70° C.). In various embodiments, the fuel cell system 104 may include other types of fuel cells, such as solid oxide fuel cells (SOFCs), molten carbonate fuel cells (MCFCs), alkaline fuel cells (AFCs), phosphoric acid fuel cells (PAFCs), and/or direct methanol fuel cells (DMFCs).

The fuel cell system 104 may include an anode loop 108, a cathode loop 110, and a high voltage (HV) and coolant circuit 112. As described in greater detail below, the anode loop 108 may be configured to be supplied with hydrogen. The cathode loop 110 may be supplied with oxygen. The anode loop 108 and cathode loop 110 may supply the hydrogen and oxygen to a PEM, which converts the hydrogen into protons and electrons, the protons interacting with the oxygen for producing heat and water, and the electrons supplied as power.

The control system 102 may include one or more processors 114 and memory 116. The processor(s) 114 may be or include any device, component, element, or hardware designed or configured to perform the various steps recited herein. For example, the processor(s) 114 may include any number of general purpose single- or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. In some embodiments, the control system 102 may include a single processor 114 designed or configured to perform each of the various steps recited herein. In some embodiments, the control system 102 may include multiple processors 114 which are designed or configured perform (e.g., either separately or together) each of the various steps recited herein. As one example, the control system 102 may include a first processor 114 designed or configured to perform a first subset of the various steps, and a second processor 114 designed or configured to perform a second subset of the various steps (with the first subset being different from the second subset). As another example, the control system 102 may include first and second processors 114 which together perform the various steps in a distributed fashion. As such, unless explicitly indicated otherwise, such as by use of a term such as “a single processor”, the term “one or more processor(s)” as used herein contemplates and encompasses embodiments in which all of the one or more processors perform all of the recited steps or features, different processors separately perform different ones of the steps or features, the same or different sets of two or more processors work in combination to perform individual steps or features, or any variation thereof. In other words, unless explicitly indicated otherwise, the use of the term “one or more processors” herein contemplates and encompasses a single processor performing all of the recites steps or features and two or more processors working individually or in combination, where each step or feature is performed by any one or combination of two or more of the processors. The memory 116 may be or include any type or form of data storage device, including tangible, non-transient volatile memory and/or non-volatile memory.

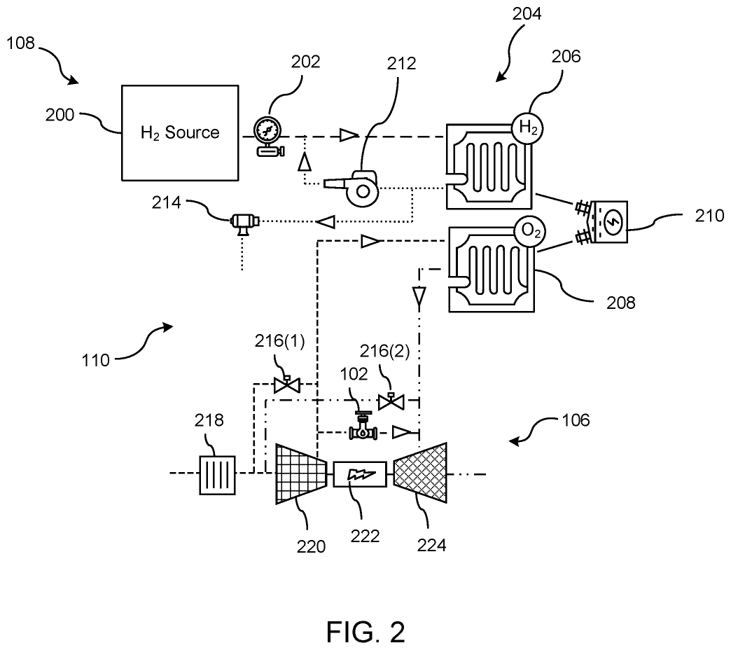

Referring now to FIG. 1 and FIG. 2, the fuel cell system 104 may include an anode loop 108 and a cathode loop 110. Specifically, FIG. 2 is a schematic diagram of anode and cathode loops 108, 110 of the fuel cell system 104, according to an embodiment of the present disclosure. As shown in FIG. 2, the anode loop 108 may include a hydrogen source 200 communicably coupled to a pressure regulator 202. The hydrogen source 200 may be configured to supply or otherwise provide hydrogen (e.g., H₂) to the pressure regulator 202. The pressure regulator 202 may be configured to increase, decrease, or otherwise regulate the supplied hydrogen from the hydrogen source 200, for supply to a proton exchange membrane (PEM) 204. Specifically, the pressure regulator 202 may be configured to supply the pressurized hydrogen to an anode catalyst 206 of the PEM 204. The cathode loop 110 may have air (e.g., ambient air) supplied thereto. Specifically, oxygen from the ambient air may be supplied to a cathode catalyst 208 of the PEM 204. Together, the hydrogen supplied to the anode catalyst 206 and oxygen supplied to the cathode catalyst 208 may operate to produce electrical energy and heat for the fuel cell. More specifically, the hydrogen may be split into protons and electrons at the anode catalyst 206, and the oxygen may combine with the protons and electrons to produce electricity and water, with heat generated as a byproduct. The electrons may flow to an electrical power circuit 210 (e.g., a high-voltage bus) to generate electrical power, while the protons may move through the PEM 204 to facilitate the electrochemical reactions for producing the water and heat. Diluted hydrogen may be fed back into the anode loop 108 via a hydrogen compressor 212, as well as out of the system 100 as exhaust via a valve 214.

The fuel cell system 106 may include various actuators 120. The actuators 120 may include pumps, valves, regulators, diverters, or any other actuators designed or configured to control the flow of a fluid. For instance, the cathode loop 110 may include various actuators 120 for regulating the flow of air to or from the cathode catalyst 208. For example, the cathode loop 110 may include recirculation valves 216(1), 216(2) for selectively recirculating air back to the compressor 220. As shown in FIG. 2, and in some embodiments, the cathode loop 110 may include a recirculation valve 216(1) arranged to supply heated air from the compressor 220 (e.g., output by the compressor) back to an input of the compressor 220. In such an example, at least a portion of the heated air may be heated twice, then re-output by the compressor 220 towards the cathode catalyst 208. Additionally or alternatively, the cathode loop 110 may include a recirculation valve 216(2) arranged to supply heated air already supplied to the cathode catalyst 208 back to the compressor 220. In such an example, the heated air supplied to and passing through the cathode may be recirculated, rerouted, or otherwise diverted (e.g., via the recirculation valve 216(2), back to an inlet of the compressor 220.

Similarly, the anode loop 108 may include various actuators 120 for controlling the flow of hydrogen to the anode catalyst 206. For example, the cathode loop 110 may include the pressure regulator 202 and the hydrogen compressor 212. Additionally, the HV and coolant circuit 112 may include various actuators 120 for controlling the flow of coolant. For example, the HV and coolant circuit 112 may include various pumps 300 and a thermostat 124 with an included actuator, for controlling the flow of coolant through the coolant circuit 112. The cathode loop 110 may include an air filter 218 arranged at an inlet to the cathode loop 110, to filter air prior to entering the cathode loop 110.

The system 100 may include a compressor system 106. In various embodiments, the compressor system 106 may be or include a turbo compressor system 106. The compressor system 106 may be communicably coupled to the control system 102 and powered by a battery source 122. In this regard, the compressor system 106 may be or include an eTurbo (e.g., an electric turbo) compressor system 106. The battery source 122 may be an external battery source separate from the electrical power circuit 210. In some embodiments, the battery source 122 may be charged by or using electrical power of the electrical power circuit 210. As shown in FIG. 2, the compressor system 106 may include a compressor 220, a turbo charger 222, and an expander 224. The compressor 220 may receive air input (e.g., downstream from the filter 218), and compress the air to supply pressurized, and correspondingly heated, air to the cathode catalyst 208. The turbo charger 222 may be configured to use or leverage energy from the flow of exhaust gases from the system 100 to drive the compressor 220 (e.g., together with the battery source 122). The expander 224 may be configured to recover some of the energy from the pressurized gas. The cathode loop 110 may include a bypass valve 226, to divert air from the compressor 220 to the cathode catalyst 208 to the expander 224. In various embodiments, the recirculation valves 216 may form a recirculation line arranged to direct warm air (e.g., after the compressed heated air is supplied to the cathode catalyst 208 by the compressor 220) back to the inlet of the compressor 220. Such implementations may further raise the temperature of compressed and heated air output by the compressor 220, thereby increasing the temperature of the fuel cell system 104 faster.

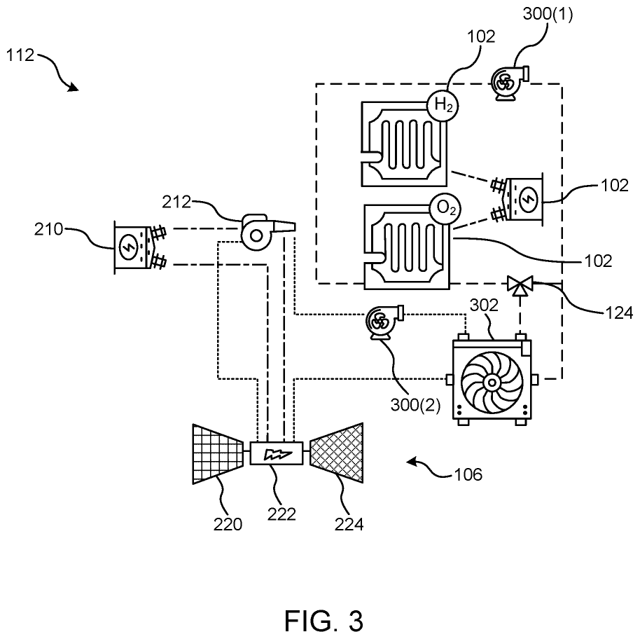

Referring now to FIG. 1 and FIG. 3, the fuel cell system 104 may include a high-voltage and coolant circuit 112. More specifically, FIG. 3 is a schematic diagram of coolant and high voltage circuits 112 of the fuel cell system 104, according to an embodiment of the present disclosure. The coolant circuit 112 may include various pumps 300 for pumping coolant through the coolant circuit. For example, a first pump 300(1) may pump high temperature coolant through the PEM 204, and a second pump 300(2) may pump low temperature coolant from the hydrogen compressor 212 and compressor system 106 through the coolant circuit 112. The coolant circuit 112 may include a heat exchanger 302. The heat exchanger 302 may be configured to transfer absorbed heat from the coolant to an external fluid (e.g., air or some other cooling medium) to dissipate heat, and/or preheat incoming coolant. The coolant circuit 112 may include one or more sensor(s) 124 arranged to measure, detect, or otherwise quantify a temperature of coolant of the coolant circuit 112. In some embodiments, the sensor(s) 124 may be or include temperature sensors arranged to measure the temperature of the coolant. For example, the sensor(s) 124 may be a thermostat, which may include a valve for controlling the flow of coolant to the heat exchanger 302.

As shown in FIG. 2 and FIG. 3, the compressor 220 may be arranged to supply compressed (and thus heated) air to the coolant circuit 112. Specifically, as shown in FIG. 2, the compressor 220 may supply compressed and heated air to the cathode catalyst 208 of the PEM 204 (e.g., the air side of the stack of the PEM 204), and as shown in FIG. 3, the high temperature coolant may pump through the cathode catalyst 208. In this regard, by supplying pressurized heated air to the cathode catalyst 208, the compressor 220 is arranged to also supply pressurized heated air to the coolant circuit.

Referring generally to FIG. 1 through FIG. 3, at various instances, the coolant may not have a sufficiently high temperature to facilitate power production via the fuel cell system 104. Such instances may include, for example, the fuel cell system 104 being turned on or activated following a long idle (or non-running) time. In such instances, the coolant may need to be heated prior to production of power via the fuel cell system 104.

The control system 102 may be configured to detect, determine, or otherwise identify a warm-up condition of the fuel cell system 104. In some embodiments, the control system 102 may be configured to identify the warm-up condition of the fuel cell system 104 based on data from a timer. For example, the control system 102 may measure a duration or time from a previous run-time of the fuel cell system 104. The control system 102 may identify the warm-up condition responsive to the measured duration satisfying a threshold (e.g., being greater than or equal to a duration corresponding to the warm-up condition). The threshold may be set based on the particular fuel cell system 104, an estimated time in which heat of the fuel cell system 104 naturally dissipates, etc. In some embodiments, the control system 102 may be configured to identify the warm-up condition of the fuel cell system 104 based on data from a sensor 124. For example, the control system 102 may be configured to identify the warm-up condition of the fuel cell system 104 responsive to a temperature of coolant of the HV and coolant circuit 112 satisfying a threshold (e.g., being less than or equal to a threshold temperature of coolant for operating the fuel cell system 104 for producing power).

The control system 102 may be configured to activate the compressor system 106 to supply compressed heated air to the coolant circuit 112 during the warm-up condition. The control system 102 may be configured to activate the compressor system 106 responsive to identifying the warm-up condition. In some embodiments, the control system 102 may activate the compressor system 106 by sending a signal to the battery source 122 to supply power to the compressor system 106. In some embodiments, the control system 102 may activate the compressor system 106 to run at a high speed and high pressure ratio, to compress and heat air supplied to the cathode loop 110. The compressor 220 may be configured to heat the air to high temperature (up to 200° C.) at, e.g., maximum compressor system 106 speed (when the turbo charger 222 and battery source 122 are driving the compressor system 106 at maximum speed or output). The compressor 220 may be arranged or configured to supply the high pressure and temperature air through the fuel cell stack (e.g., the cathode catalyst 208) to warm up the stack itself and the coolant circuit 112. The compressor 220 may be arranged to supply the high pressure and temperature air through the cathode loop 110 (O₂/air side) of the fuel cell stack (e.g., the PEM 204) and transfers heat to the stack (e.g., the cathode catalyst 208) and coolant circuit 112.

In various embodiments, the control system 102 may be configured to operate the recirculation valve(s) 216 to direct warm air back into the compressor 220 inlet (e.g., upstream from the filter 218), to raise the temperature of the compressor outlet air for a given input power. The higher temperature and/or reduced power draw may facilitate optimized heating times as compared to energy usage.

The control system 102 may be configured to operate the pumps 300 to circulate coolant through the coolant circuit 112. The control system 102 may also control the thermostat 124 to bypass flow to the heat exchanger 302. For example, the control system 102 may circulate coolant through the coolant circuit 112 while bypassing the heat exchanger 302 while the warm-up condition is present. As the coolant circulates through the coolant circuit 112, the compressed and heated air may heat up the coolant. The control system 102 may be configured to monitor (e.g., via the sensor data from the sensor(s) 124) the temperature of the coolant as the coolant is heated by the compressor 220. Once the coolant (and stack of the fuel cell system 104) reach a temperature which satisfies a threshold criteria (e.g., a minimum startup temperature in which the fuel cell system 104 can generate power and heat), the control system 102 may be configured to control the thermostat 124 to permit flow of the coolant to the heat exchanger. In this regard, the fuel cell power and compressor system 106 power may be managed during the warm-up period, to thereby optimize power usage and consumption during warm-up.

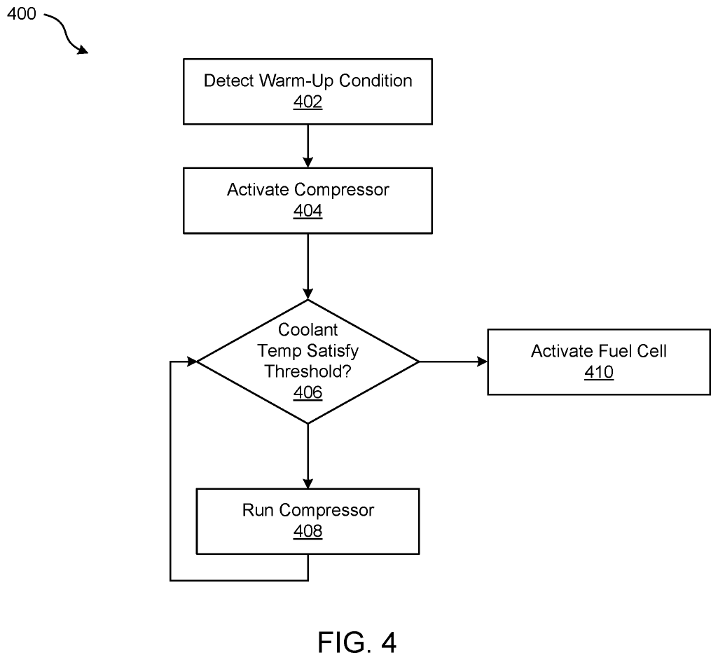

Referring now to FIG. 4, depicted is a flowchart showing an example method 400 of accelerating fuel cell start-up and warm-up times, according to an example implementation of the present disclosure. The method 400 may be performed by, implemented on, or otherwise executed by the components, elements, or hardware described above with reference to FIG. 1 through FIG. 3. For example, the method 400 may be executed by the control system 102 of FIG. 1. As a brief overview, at step 402, the control system 102 may detect a warm-up condition. At step 404, the control system 102 may activate the compressor 220. At step 406, the control system 102 may determine whether a temperature satisfies a threshold. At step 408, the control system 102 may continue to run the compressor 220. At step 410, the control system 102 may activate the fuel cell.

At step 402, the control system 102 may detect a warm-up condition. In some embodiments, the control system 102 may detect the warm-up condition of the fuel cell (or fuel cell system 104). In some embodiments, the control system 102 may detect the warm-up condition responsive to activation or ignition of, or otherwise starting the system 100 on which the fuel cell is incorporated. For example, where the fuel cell system 104 is incorporated in a vehicle or heavy machinery, the control system 102 may detect the warm-up condition responsive to the vehicle or heavy machinery being started or otherwise turned on (e.g., from an off or idle state). In some embodiments, the control system 102 may detect the warm-up condition based on a duration in which the fuel cell system 104 has been off or idle. In some embodiments, the control system 102 may detect the warm-up condition based on a measured or sensed temperature of the coolant of the fuel cell system 104 (or another component or element of the fuel cell system 104, such as a stack of the fuel cell system 104).

At step 404, the control system 102 may activate the compressor 220. In some embodiments, the control system 102 may activate the compressor 220 to supply compressed heated air to the coolant circuit 112 during the warm-up condition. In some embodiments, the compressor 220 may be arranged to supply the compressed heated air to the coolant circuit 112 and a stack of the fuel cell (e.g., the cathode catalyst 208, or air side, of the fuel cell system 104). The control system 102 may activate the compressor 220 by causing the battery source 122 to supply battery power to the compressor. Whereas some compressors may run at low speed and low pressure ratio at startup, idle, and low load conditions, the control system 102 may activate the compressor 220, to drive the compressor 220 at a high speed and high pressure ratio, to heat the air to a high temperature. The control system may override normal operational modes of the compressor 220, to drive the compressor 220 at the high speed and high pressure ratio.

In some embodiments, the control system 102 may activate, control, or otherwise actuate one or more of the recirculation valves 216. The control system 102 may actuate the recirculation valves 216 to divert, supply, or otherwise direct warm air suppled to the coolant circuit 112 back to an inlet of the compressor 220. The control system 102 may, in some embodiments, disable power production by the fuel cell system 104 (e.g., by diverting coolant from the heat exchanger 302). The control system 102 may disable power production by the fuel cell system during the warm-up condition.

At step 406, the control system 102 may determine whether a temperature satisfies a threshold. In some embodiments, the control system 102 may monitor the temperature of the coolant and/or the stack of the fuel cell system 104 being heated by the compressor 220, as the compressor 220 supplies the compressed heated air to coolant circuit 112 and stack of the fuel cell system 104. The control system 102 may monitor the temperature, to determine whether the temperature satisfies a temperature threshold. The temperature threshold may be, include, or correspond to a minimum temperature of the coolant and/or stack of the fuel cell system 104. The minimum temperature may be a minimum temperature at which the fuel cell system 104 begins to produce power.

Where, at step 406, the temperature does not satisfy the threshold (e.g., the temperature of the coolant and/or stack of the fuel cell system 104 is less than the temperature threshold corresponding to the minimum temperature), the method 400 may continue to step 408, where the control system 102 continues to run the compressor 220. In this regard, the control system 102 may operate the compressor to supply compressed heated air to the coolant circuit 112 and stack of the fuel cell system 104 until the temperature satisfies the threshold.

Once the temperature satisfies the threshold, the method 400 may continue to step 410, where the control system 102 may activate the fuel cell. The control system 102 may activate the fuel cell to supply power to the system on which the fuel cell resides (e.g., the vehicle, heavy machinery, etc.). The control system 102 may activate the fuel cell responsive to the temperature satisfying the minimum temperature at which the fuel cell system 104 begins to produce power. The control system 102 may activate the fuel cell by controlling the thermostat 124 to supply coolant to the heat exchanger 302.

### INDUSTRIAL APPLICABILITY

The disclosed embodiments may be applicable to any fuel cell-based system or solution. For example, the disclosed embodiments may be applicable to or applied to a vehicle, such as an automobile, heavy machinery, or any other type of vehicle, a power source for a home, office, or any other residential/industrial setting, or any other power delivery system which may be powered by a fuel cell. The disclosed embodiments may be applicable to fuel cell-based systems which use or include HT-PEM fuel cells, or fuel cells which are designed to operate at high temperatures (and thus may have a warm-up time involved to be operational). The disclosed compressor 220, together with the control system 102 described herein, may be provided to reduce start-up and warm-up times relative to other fuel cell systems. For example, because the compressor 220 supplies compressed and heated air to the fuel cell system 104, the fuel cell system 104 may be heated up at a faster rate than simply heating the fuel cell system 104 via the coolant circuit 112. The amount of such a reduction in start-up and warm-up times may be dependent on the level of active heating, the thermal mass of the fuel cell system 104 being heated, whether the compressor 220 includes a turbo charger 222, etc.

In various embodiments of the present solution, the compressor 220 may be driven by a battery 122, to heat the coolant and accelerate fuel cell startup and warmup times. By using an independent power source, such as a battery 122, the compressor 220 may supply compressed, heated air to the fuel cell system 104 without power being output by the fuel cell system 104. Thus, the battery 122 can supply power to the compressor 220 for heat-up and warm-up of the fuel cell system 104, and the fuel cell system 104 can supply power (e.g., once sufficiently heated) to other components or elements of the vehicle/home/endpoint powered by the fuel cell system 104.

In various embodiments, the cathode loop 110 may include various valves 216 or actuators 216 to divert heated air back to an inlet of the compressor 220, to further accelerate the fuel cell startup time. For example, the first valve 216(1) may divert at least a portion of compressed, heated air output by the compressor 220 back to the inlet of the compressor 220. By supplying that compressed, heated air back to the inlet of the compressor 220, the compressor 220 further compresses and heats the already compressed/heated air, thereby more rapidly heating the cathode loop 110. Additionally, and for similar reasons, the second valve 216(2) may divert compressed, heated air which already passed through the cathode loop back to the compressor 220, to re-heat the already heated/compressed air. Such valves 216 may further cause acceleration of the fuel cell startup and warmup times relative to other fuel cell systems. Additionally, by re-heating the heated/compressed air as described herein, the compressor system 106 may have increased efficiency by recycling already-heated/compressed air.

What is claimed is:

1. A vehicle, comprising:
a fuel cell; and
a compressor arranged to supply compressed heated air to a coolant circuit of the fuel cell; and
a processing circuit comprising one or more processors and memory, the memory storing instructions that, when executed, cause the processing circuit to:
detect a warm-up condition of the fuel cell; and
activate the compressor to supply compressed heated air to the coolant circuit during the warm-up condition.

2. The vehicle of claim 1, wherein the fuel cell comprises a high-temperature proton-exchange membrane (HT-PEM) fuel cell.

3. The vehicle of claim 1, wherein the compressor comprises an eTurbo compressor.

4. The vehicle of claim 1, wherein the compressor is arranged to supply the compressed heated air to the coolant circuit and a stack of the fuel cell.

5. The vehicle of claim 4, wherein the compressor supplies the compressed air to the coolant circuit via an air side of the stack of the fuel cell.

6. The vehicle of claim 1, further comprising:
a recirculation line arranged to direct warm air of the compressed heated air back to an inlet of the compressor.

7. The vehicle of claim 1, wherein the instructions further cause the processing circuit to:
detect, via a sensor arranged to measure a temperature of coolant of the coolant circuit, the temperature satisfies a threshold temperature; and
activate the fuel cell to supply power to the vehicle.

8. The vehicle of claim 1, further comprising a battery electrically coupled to the compressor, to supply power to the compressor during the warm-up condition.

9. An energy system for a vehicle, the energy system comprising:
a fuel cell; and
a compressor arranged to supply compressed heated air to a coolant circuit of the fuel cell; and
a processing circuit comprising one or more processors and memory, the memory storing instructions that, when executed, cause the processing circuit to:
detect a warm-up condition of the fuel cell; and
activate the compressor to supply compressed heated air to the coolant circuit during the warm-up condition.

10. The energy system of claim 9, wherein the fuel cell comprises a high-temperature proton-exchange membrane (HT-PEM) fuel cell.

11. The energy system of claim 9, wherein the compressor comprises an eTurbo compressor.

12. The energy system of claim 9, wherein the compressor is arranged to supply the compressed heated air to the coolant circuit and a stack of the fuel cell.

13. The energy system of claim 12, wherein the compressor supplies the compressed air to the coolant circuit through an air side of the stack of the fuel cell.

14. The energy system of claim 9, further comprising:
a recirculation line arranged to direct warm air of the compressed heated air back to an inlet of the compressor.

15. The energy system of claim 9, wherein the instructions further cause the processing circuit to:
detect, via a sensor arranged to measure a temperature of coolant of the coolant circuit, the temperature satisfies a threshold temperature; and
activate the fuel cell to supply power to the vehicle.

16. The energy system of claim 9, further comprising a battery electrically coupled to the compressor, to supply power to the compressor during the warm-up condition.

17. A method of heating an energy system during a start-up condition, the method comprising:
detecting, by a control system, a warm-up condition of a fuel cell for an energy system of a vehicle; and
activating, by the control system, a compressor to supply compressed heated air to a coolant circuit of the fuel cell during the warm-up condition.

18. The method of claim 17, wherein the compressor is arranged to supply the compressed heated air to the coolant circuit and a stack of the fuel cell.

19. The method of claim 18, wherein the compressor supplies the compressed air to the coolant circuit through an air side of the stack of the fuel cell.

20. The method of claim 17, further comprising:
detecting, by the control system via a sensor arranged to measure a temperature of coolant of the coolant circuit, the temperature satisfies a threshold temperature; and
activating, by the control system, the fuel cell to supply power to the vehicle.
